(19) United States
(12) Patent Application Publication
(10) Pub. No.: US 2006/0233279 A1
(43) Pub. Date: Oct. 19, 2006

(54) System and method of adjusting output voltage of a transmitter based on error rate

(76) Inventors: Brian D. Ryder, Tomball, TX (US); Ann N. Alejandro, Houston, TX (US); Michael Gove, Humble, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/105,278

(22) Filed: Apr. 13, 2005

(51) Int. Cl. H04L 25/03

(52) U.S. Cl. 375/296

(57) ABSTRACT

In accordance with an embodiment of the invention, a system comprises control logic and a transmitter. The transmitter is operatively coupled to the control logic and has an output voltage. The control logic adjusts a magnitude of the output voltage based on an error rate associated with the transmitter.

### BACKGROUND

Communications typically involve a transmitter to transmit data and a receiver operatively coupled to the transmitter to receive the data. Power is consumed in the communications process. Reducing power consumption is desirable, particularly for battery-operated equipment.

### BRIEF DESCRIPTION OF THE DRAWINGS

For a detailed description of exemplary embodiments of the invention, reference will now be made to the accompanying drawings in which:

FIG. 1 shows a system diagram in accordance with an embodiment of the invention;

FIG. 2 shows a system diagram in accordance with another embodiment of the invention;

FIG. 3 shows a method embodiment; and

FIG. 4 shows a method embodiment.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more components and may be used, for example, to refer to a computer system or a subsystem of a computer.

### DETAILED DESCRIPTION

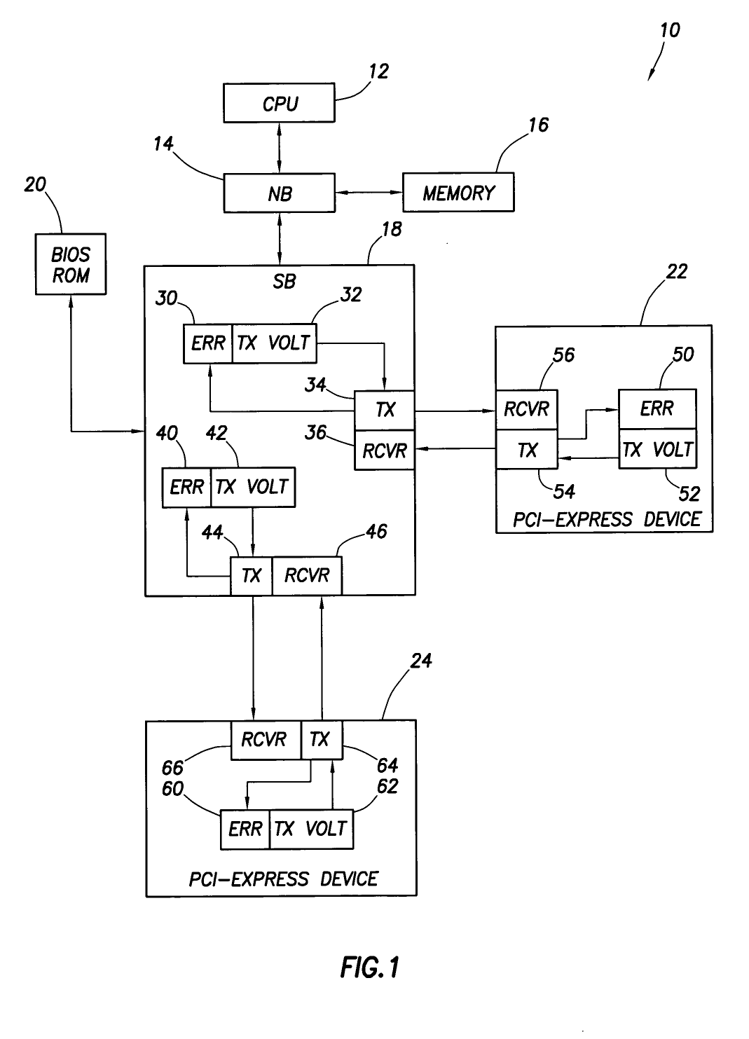

Referring now to FIG. 1, a system 10 is shown comprising a central processing unit (CPU) 12, a pair of bridge devices 14 and 18, memory 16, a read only memory (ROM) 20, and one or more peripheral devices 22 and 24. The bridge devices 14 and 18 comprise a north bridge 14 and a south bridge 18. The north bridge 14 couples to the CPU 12, memory 16 and south bridge 18 to provide communications there between. The south bridge 18 couples to the ROM 20 and peripheral devices 22 and 24.

The ROM 20 stores a basic input/output system (BIOS) executable code. The BIOS is executed by the CPU 12 during system initialization and copied to memory 16 for further execution therefrom. The BIOS causes the CPU 12 to perform one or more functions such as those described herein.

The peripheral devices 22 and 24 can be any type of peripheral device. For example, the peripheral devices may comprise a network interface controller (NIC) or a modem. In accordance with at least one embodiment of the invention, each peripheral device 22 and 24 interfaces with the south bridge 18 via a Peripheral Component Interconnect (PCI)-Express bus. In such an embodiment, each peripheral device 22 and 24 is PCI-Express-compatible.

The south bridge 18 comprises a bus interface for each of the peripheral devices 22, 24. The interface to peripheral device 22 comprises a transmitter 34 and receiver 36. This interface also comprises storage for an error rate value and a transmitter output voltage value. The error rate value is indicative of the rate of occurrence of transmission errors across the bus between south bridge 18 and peripheral device 22. The transmitter output voltage value is a value that is indicative of the desired output voltage magnitude of the associated transmitter (i.e., transmitter 34). In some embodiments, the transmitters are differential transmitters and the output voltage magnitude is the output voltage swing of the transmitter. This output voltage swing is dynamically programmable based on error rate. The storage may comprise, for example, a register for each of the aforementioned values. In the embodiment shown in FIG. 1, the storage comprises a first register 30 in which the error rate value can be stored and read, and a second register 32 in which a desired transmitter output voltage swing value can be stored to program the output voltage swing of the associated transmitter. The transmitter 34 outputs data to a receiver 56 in the peripheral device 22. Likewise, the receiver 36 in the south bridge receives data from a transmitter 54 in the peripheral device 22. The peripheral device 22 comprises a bus interface to the south bridge 18. The interface in the peripheral device 22 comprises the transmitter 54, the receiver 56, and storage for error rate values and transmitter output voltage values. As shown, the storage comprises a first register 50 in which the error rate values can be stored and a second register 52 into which the transmitter output voltage values can be stored.

The system 10 may comprise only a single peripheral device 22 in some embodiments. However, in other embodiments, such as that shown in FIG. 1, more than one peripheral device may be included. If additional peripheral devices are coupled, the south bridge 18 comprises a bus interface for each such peripheral device. For example, in the embodiment of FIG. 1, the south bridge 18 comprises a bus interface for the peripheral device 24. Such interface includes a transmitter 44, a receiver 46, and storage for error rate and transmitter output voltage values. Such storage comprises a first register 40 into which error rate values can be stored and a second register 42 into which transmitter output voltage values can be stored. The peripheral device 24 comprises a bus interface similar to that of peripheral device 22. Specifically, the interface in peripheral device 24 comprises a transmitter 64, a receiver 66, and storage (first and second registers 60 and 62) into which error rate and transmitter output voltage values, respectively, can be stored as shown.

The operation of system 10 in FIG. 1 will now be described. The following discussion focuses on the programmability of transmitter 34 in the south bridge 18, but such discussion applies equally to transmitters 44, 54, and 64 as well. Transmitter 34 is programmable and more specifically, the magnitude of the output voltage swing of the transmitter is programmable. In accordance with various embodiments of the invention, the programmability of the output voltage swing of transmitter 34 is based on an error rate associated with transmitter 34.

The error rate associated with the transmitter 34 can be determined or otherwise measured in accordance with any suitable technique. For example, Cyclic Redundancy Check (CRC) bits can be computed and used to detect transmission errors. Computing the number of errors in a predetermined or programmable period of time leads to an error rate. The error rate of the transmitter 34 is periodically determined (e.g., once per second, once per minute, etc.) and a value associated with the determined error rate is stored in register 30. By examining the error rate value stored in register 30, the system 10 can periodically ascertain the state of the error rate of transmitter 34. Control logic periodically monitors register 30 to ascertain the error rate value and, based on the error rate, accordingly adjusts the transmitter output voltage swing of the transmitter 34. In the embodiment of FIG. 1, the control logic comprises the CPU 12 executing the BIOS from BIOS ROM 20. The control logic (CPU 12 executing BIOS code) reads the error value from register 30 and compares the error value to one or more thresholds. If the error rate value exceeds a first threshold, then the control logic programs the second register 32 to have a transmitter output voltage value that causes the transmitter 34 to operate at a higher output voltage swing. The first threshold is set a level above which it is determined that the error rate of the transmitter 34 is unacceptable. The threshold can be fixed or programmable. The error rate can be reduced by increasing the transmitter's output voltage swing and this is what the control logic does via programmable register 32.

In some embodiments, a pair of thresholds can be provided—a first threshold and a second threshold. The first threshold is greater than the second threshold The first threshold represents an error rate level above which error rates are deemed excessive. The second threshold, which is lower than the first threshold, is implemented to create hysteresis if desired. Accordingly, the transmitter's output voltage swing is increased if the associated error rate exceeds the first threshold. The output voltage swing is decreased if the error rate falls below the second threshold. By enabling the transmitter voltage swing to be decreased, system power can be conserved which is generally beneficial, particular for battery-operated system. Further, the technique described herein enables the transmitter output voltage swing to be set, for a given desired error rate, at a fairly low level but nevertheless at a level sufficient to achieve the desired error rate.

The control logic may perform the same functions as those described above with respect to the other transmitters 44, 54, and 64. In some embodiments, the control logic may program each of the four transmitters independently from each other as desired.

The control logic of FIG. 1 (CPU 12 executing the BIOS code) may perform the aforementioned functions during system initialization and periodically during run-time. During run-time, the control logic may adjust the output voltage swings of the various transmitters at a predefined time interval such as once every second, minute, ten minutes, etc. This time period can be programmable.

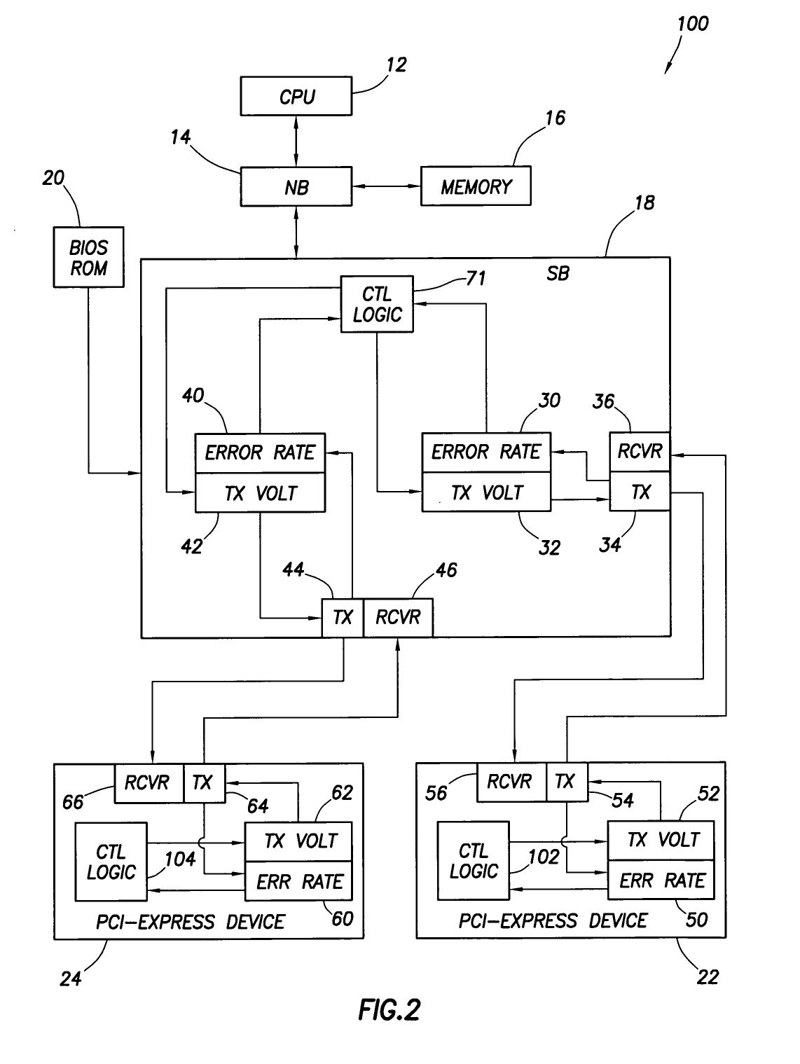

FIG. 2 shows a system 100 similar to that of FIG. 1. In FIG. 2, however, south bridge 18 includes control logic 71, in addition to the various transmitters 34, 44, receivers 36, 46, and programmable registers 30, 32, 40, 42. As such, the control logic 71 is embedded within south bridge 18. Similarly, peripheral devices 22 and 24 each include control logic. Control logic 102 is included in peripheral device 22 and control logic 104 is included in peripheral device 24. The functions attributed to the control logic of FIG. 1 (the CPU executing the BIOS code) is performed by the various control logic circuits 71, 102, and 104 of FIG. 2. For example, the control logic 71 of the south bridge 18 in FIG. 2 periodically monitors error rate values from registers 30 and 40 and, based on a comparison of those error rate values with associated thresholds as described above, re-programs the transmitter output voltage registers 32 and 42 to cause changes to be made in the output voltages of transmitters 34 and 44 as described above. Similarly, the control logic of 102 monitors the error rate of peripheral device 22 and adjusts the output voltage swing of transmitter 54 by writing new values to register 52. The control logic 104 of peripheral device 24 monitors the error rate of transmitter 64 and, based on a comparison of that error rate with associated thresholds, adjusts the magnitude of the output voltage swing of the transmitter 64 by writing new values to the register 62.

In the embodiment of FIG. 2, control logic embedded within each bus device 18, 22, and 24 dynamically (i.e., during run-time) monitors the associated error rates and accordingly adjusts the transmitter's output voltage swings. In some embodiments, the CPU 12 initializes the values in the transmitter output voltage registers 42, 52, and 62 during system initialization by executing the BIOS code. Thereafter, the control logic circuits 71, 102, and 104 continue to perform the function of monitoring error rates and adjusting the transmitter output voltage swings without involvement of the CPU 12. If desired, however, the CPU 12 may periodically monitor the error rates of devices 18, 22, 24 under control of the BIOS on a predefined polling interval, while control logic circuits 71, 102, 104 also monitor the error status of the associated transmitters and react accordingly to increase transmitter output voltage swing as indicated.

FIG. 3 shows a method embodiment comprising actions 130 and 132. At 132, the method comprises determining an error rate associated with a transmitter. This action can be performed by any of the embodiments described above such as CPU 12 under control of BIOS 20 or any of the control logic circuits 71, 102, and 104. At 132, the method comprises programming the output voltage magnitude of a transmitter based on the associated error rate. Again, this action can be performed by either the CPU 12 under control of the BIOS or by any of the control logic circuits 71, 102, and 104.

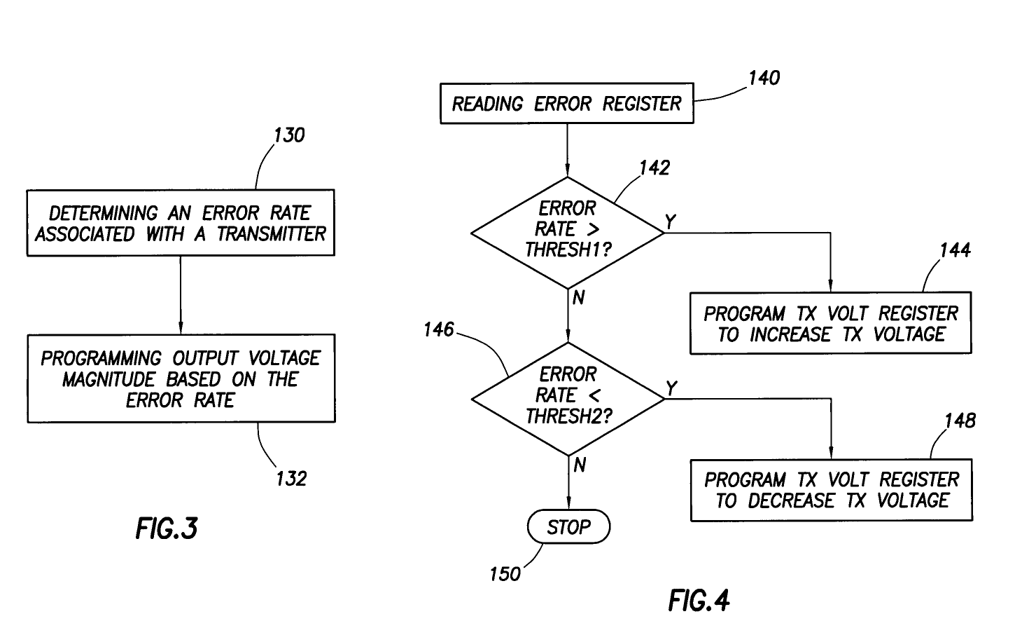

FIG. 4 shows a more detailed method embodiment comprising actions 140-150 which compare the error rate to a pair of thresholds as described above. At 140, the method comprises reading an error rate register such as registers 30, 50, and 60. If the error rate value read from the associated register is greater than a first threshold, as determined in decision action 142, control passes to action 144 in which the method comprises programming the transmitter voltage register to increase the transmitter output voltage swing. If, however, the error rate is not greater than the first threshold, control passes to decision action 146 in which the error rate value is compared to a second threshold. If the error rate is less than a second threshold, and in the embodiments described herein the second threshold is less than the first threshold, control passes to action 148 in which the transmitter voltage register is programmed so as to decrease the transmitter output voltage swing. Because the error rate of the associated transmitter is low enough, it is determined that the transmitter's output voltage swing can be reduced. If the error rate is not less than the second threshold, the method terminates at 150. The method embodiments of FIGS. 3 and 4 can be performed during run-time and, as described above, can be performed at periodic intervals during run-time.

The above discussion is meant to be illustrative of the principles and various embodiments of the present invention. Numerous variations and modifications will become apparent to those skilled in the art once the above disclosure is fully appreciated. For example, rather than having the CPU 12 or various control logic circuits 71, 102, 104 poll the various error rate registers, the hardware can be configured to implement an interrupt when an error rate exceeds the first threshold or falls below the second threshold. Further still, although a single register is shown for each of a number of different uses (e.g., register 30 in which error rate values are stored, register 32 in which transmitter output voltage values are stored, etc.), more than one register can be used to store values of a certain type. It is intended that the following claims be interpreted to embrace all such variations and modifications.

What is claimed is:

1. A system, comprising:
control logic; and
a transmitter operatively coupled to said control logic, said transmitter having an output voltage;
wherein said control logic adjusts a magnitude of the output voltage based on an error rate associated with said transmitter.

2. The system of claim 1 further comprising a register into which said error rate is written, and wherein said control logic uses the error rate from the first register to adjust the magnitude.

3. The system of claim 1 further comprising a register into which said control logic writes a value to adjust the magnitude.

4. The system of claim 1 wherein said control logic adjusts the magnitude multiple times during run-time of said system.

5. The system of claim 1 wherein said control logic comprises a central processing unit (CPU).

6. The system of claim 5 wherein said CPU periodically ascertains the error rate and compares the periodically ascertained error rate to a threshold to determine whether to adjust the magnitude.

7. The system of claim 1 wherein said control logic compares the error rate to a first threshold and, if said error rate exceeds said first threshold, said control logic increases the magnitude.

8. The system of claim 7 wherein said control logic also compares the error rate to a second threshold that is lower than the first threshold, and said control logic decreases the magnitude if the error rate is less than the second threshold.

9. The system of claim 1 wherein said control logic compares the error rate to a threshold and, if said error rate is less than the threshold said control logic decreases the magnitude.

10. The system of claim 1 further comprising a bus interface that comprises said transmitter and said control logic.

11. The system of claim 1 further comprising a plurality of transmitters, each having an output voltage magnitude that is adjustable by said control logic based on an associated error rate.

12. The system of claim 12 wherein said transmitter has a differential output voltage and the magnitude is a magnitude of a voltage swing associated with said differential output voltage.

13. A bus device, comprising
a transmitter having a programmable output voltage; and
storage into which an error rate value is written, said error rate value indicating an error rate associated with said transmitter;
wherein the output voltage of said transmitter is adjustably programmed based on the error rate value in said storage.

14. The bus device of claim 13 wherein said bus device comprises bus bridge.

15. The bus device of claim 13 wherein said bus device is a peripheral device adapted to couple to a bridge device.

16. The bus device of claim 13 further comprising control logic operatively coupled to the storage and which reads the error rate value from the storage and which programs the transmitter's output voltage based on the error rate value.

17. The bus device of claim 16 further comprising storage into which an output voltage value is written by said control logic to program the output voltage.

18. The bus device of claim 13 further comprising storage into which an output voltage magnitude value can be written to program a magnitude of the transmitter's output voltage.

19. The bus device of claim 13 wherein the output voltage is increased if the error rate exceeds a first threshold.

20. The bus device of claim 19 wherein the output voltage is decreased if the error rate is less than a second threshold, the second threshold being less than the first threshold.

21. The bus device of claim 13 wherein the output voltage is programmed during run-time of the bus device.

22. A system, comprising:
means for transmitting a signal to include data; and
means for dynamically changing a magnitude of the signal based on an error rate associated with said system.

23. The system claim 22 further comprising means for increasing the magnitude if the error rate exceeds a first threshold.

24. The system of claim 23 further comprising means for decreasing the magnitude if the error rate falls below a second threshold, said second threshold being less than the first threshold.

25. A method, comprising:
determining an error rate associated with a transmitter; and
programming a magnitude of an output voltage of the transmitter based on the error rate.

26. The method of claim 25 wherein determining the error rate and programming the magnitude both occur repeatedly during run-time.

27. The method of claim 25 wherein programming the magnitude comprises increasing the magnitude if the error rate exceeds a first threshold and decreasing the magnitude if the error rate falls below a second threshold.
